(19) United States
(12) Patent Application Publication
(10) Pub. No.: US 2012/0006881 A1
(43) Pub. Date: Jan. 12, 2012

(54) Flux Cored Preforms for Brazing

(76) Inventors: Charles E. Fuerstenau, Greenville, WI (US); Alan Belohlav, Belgium, WI (US)

(21) Appl. No.: 13/010,144

(22) Filed: Jan. 20, 2011

Related U.S. Application Data
(63) Continuation of application No. 12/834,506, filed on Jul. 12, 2010.

(51) Int. Cl. B23K 35/14; B23K 35/22

(52) U.S. Cl. 228/56.3

(57) ABSTRACT

A brazing material wire preform suitable for use in brazing two components to one another. The preform is made from a length of wire having a core of flux material, and a longitudinal seam or gap that extends over the length of the wire. The seam is formed so that when heated, the flux material flows from the core and out of the seam. The length of wire is in the form of a loop having a certain circumference so that when the preform is heated, the flux material disperses uniformly from the circumference of the preform for evenly treating the surface of a component on which the preform is placed. The length of wire may include a silver alloy.

### CROSS-REFERENCE TO RELATED APPLICATIONS

This application is a continuation of and claims priority from U.S. patent application Ser. No. 12/834,506, filed on Jul. 12, 2010, the entirety of which is expressly incorporated by reference herein for all purposes.

### FIELD OF THE INVENTION

The present invention is directed to wire preforms for use in brazing.

### DISCUSSION OF THE KNOWN ART

The brazing process typically involves joining ferrous and non-ferrous metal components by positioning a brazing composition (such as an aluminum or silver-bearing metal alloy) and a flux adjacent to or between surfaces of the components to be joined, also known as the faying surfaces. To form the joint, the metal alloy, flux, and the faying surfaces are heated to a temperature typically above the melting temperature of the alloy but below the melting temperature of the components to be joined. The alloy then melts, flows into the faying surfaces by capillary action and forms a seal that bonds the faying surfaces to one another.

A flux composition is often applied to the faying surfaces prior to brazing. In one application, a flux can be selected so that, when applied, it does one or more of the following: (1) removes oxides ordinarily present on the faying surfaces; (2) promotes the flow of the molten brazing alloy when heated to a temperature above its melting point; and (3) inhibits further oxide formation on the faying surfaces.

Flux cored wire ring preforms for brazing are known to have been made using an aluminum/silicon metal alloy. When heated, the alloy tends to melt quickly enough to allow the core flux material to disperse fairly evenly and to enable satisfactory joints to be made. A known supplier of flux cored aluminum ring preforms is Omni Technologies Corporation.

Initial attempts to make silver alloy flux cored braze ring preforms using the same design principles as the aluminum preforms met with little initial success. Specifically, when the silver preforms were heated, the flux would not disperse evenly about the rings but, rather, would exit only from opposite ends of the silver wire forming the preforms before the melting of the wire itself. As a result, the braze joints were poor.

Accordingly, there is a need for a flux cored brazing ring preform that, during heating, will disperse its core flux material evenly about the ring and onto a surface to be treated for brazing. In particular, there is a need for such preforms made of silver alloys.

### SUMMARY OF THE INVENTION

The present invention is directed to a flux cored brazing preform. A metal alloy is provided as an elongated thin sheet that is rolled around its long axis so as to encase a flux material. The rolled metal alloy sheet thus forms a flux cored wire having a longitudinal seam through which the flux material, when in a molten state, can exit.

The flux cored wire is then shaped into a braze ring preform which, when heated, allows the encased flux material to flow uniformly from the seam about the circumference of the preform, and to disperse evenly for treating a surface to be brazed.

### BRIEF DESCRIPTION OF THE DRAWINGS

In the drawings:

FIG. 1 is a flow chart depicting a method of producing lengths of seamed brazing wire for shaping into brazing preforms according to the invention;

FIG. 2 is a cross-sectional view of the brazing wire produced according to FIG. 1; and

FIGS. 3 to 5 show brazing preforms according to the invention.

### DETAILED DESCRIPTION OF THE INVENTION

In general, seamed flux cored brazing wires can be produced in accordance with procedures disclosed in French Patent Application no. 78 12546, published Nov. 25, 1977, and the seam area of the rolled sheet of metal may be modified as described herein. Other seamed flux cored brazing or welding wires are disclosed in, for example, U.S. Pat. No. 3,935,414 (Jan. 27, 1976); U.S. Pat. No. 1,629,748 (May 24, 19271); U.S. Pat. No. 4,379,811 (Apr. 12, 1983); U.S. Pat. No. 2,958,941 (Nov. 8, 1960); U.S. Pat. No. 4,396,822 (Aug. 2, 1983); U.S. Pat. No. 3,642,998 (Nov. 24, 1970); and Japanese Patent No. 63-303694 (Dec. 1, 1988).

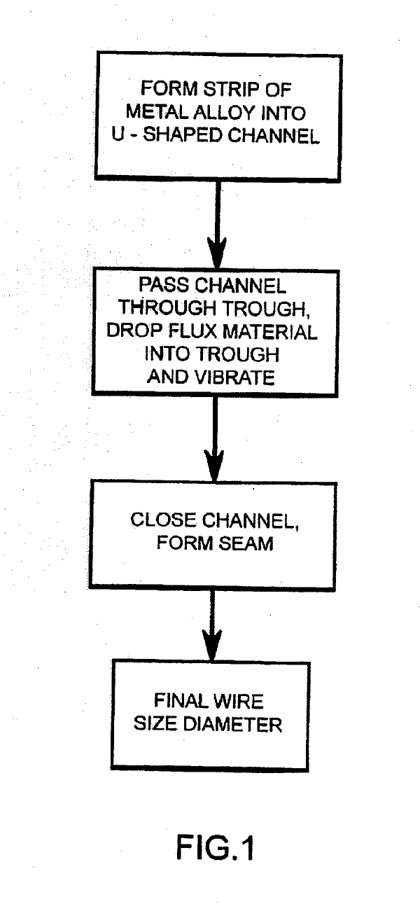

As represented in FIG. 1, a narrow elongate strip of a metal alloy, which may have been coiled onto a spool to facilitate the feeding thereof during the manufacturing process, is formed into a U-shaped channel by a first die. The U-shaped channel is passed through a trough by pulling the strip in a direction away from the spool or other dispensing apparatus. A powdered flux material is conveyed from a dispenser so as to drop from the dispenser into a trough, which contains the U-shaped channel and to over-fill the trough. A vibrating apparatus is typically employed to vibrate the trough in order to fill the strip. Optionally, lasers may be employed to ensure that the amount of flux that fills the metal alloy strip is sufficient to form an adequate brazed joint. The filled strip is passed out of the trough, through a second die where the filled channel begins to close. The wire then passes through a third die where the wire is closed and a butt seam is formed with the opposing side edge portions of the strip.

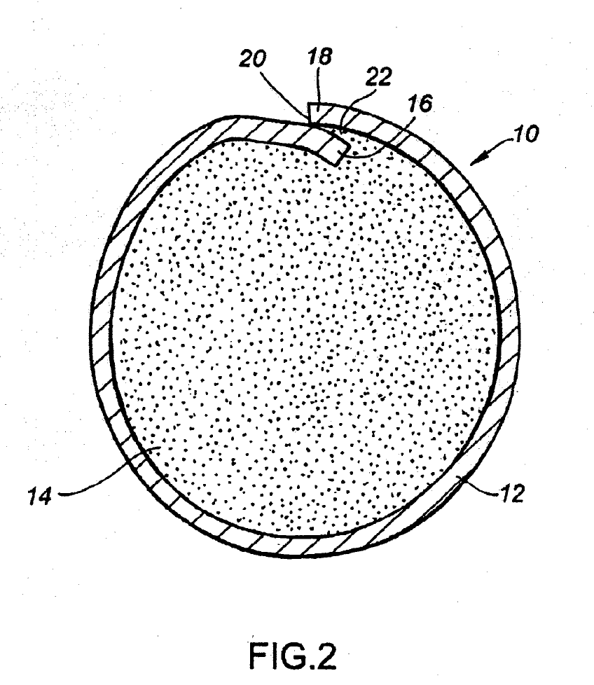

The wire then passes through a fourth die which forces an edge portion of the seam inward, e.g., about 0.005″ to 0.010″. This portion is maintained to about 45 degrees or less of the circumference of the wire and leaves a gap between the opposed edge portions of the strip. The inner edge portion extends toward the center of the cored wire and the space between the edge portions contains flux. See FIG. 2. It is believed that this creates a path for the flux in the center of the core to release from the core.

The wire then passes through a fifth die where the wire is formed to its final size diameter, while maintaining the seam as described above. The flux cored wire is then packaged on spools and other suitable packaging systems.

The metal alloy strip can be any of the following alloys, among others: aluminum-silicone; zinc-aluminum; copper zinc; silver-copper-zinc; silver-copper-zinc-tin; silver copper-zinc-tin-nickel; silver-copper-zinc-nickel; silver-copper-tin; silver-copper-zinc-manganese-nickel; silver-copper-zinc-cadmium; and silver-copper-zinc-cadmium and nickel.

The flux-cored brazing wire formed as described above can subsequently be formed to into brazing preforms having any desired shape, such as a circle or oval. The preforms can then be placed between or adjacent to faying surfaces of components to be joined. The preforms and the faying surfaces are then heated to a suitable brazing temperature sufficient to melt the flux and the brazing alloy and, thus, bond the faying surfaces. The components are then cooled to solidify the brazing alloy and to secure the bond between the faying surfaces.

As shown in cross-section in FIG. 2, the flux cored wire 10 includes the rolled metal alloy sheet 12 that defines an encasing perimeter that extends around the flux material 14 of the core. An inner angled edge portion 16 of the sheet 12 is embedded in the flux material 14. Moving counter-clockwise in FIG. 2, the inner angled edge portion 16 of the sheet 12 emerges from the core and the sheet 12 extends around the flux material, and an outer edge portion 18 of the sheet 12 confronts the sheet 12 in the vicinity of the location where inner angled edge portion 16 of the sheet 12 emerges from the core, thereby forming a seam 20. Between the inner angled edge portion 16 and the outer edge portion of the sheet, there is a gap 22, in which a portion of the flux material 14 resides. Also, the inner angled edge portion 16 is surrounded by flux material.

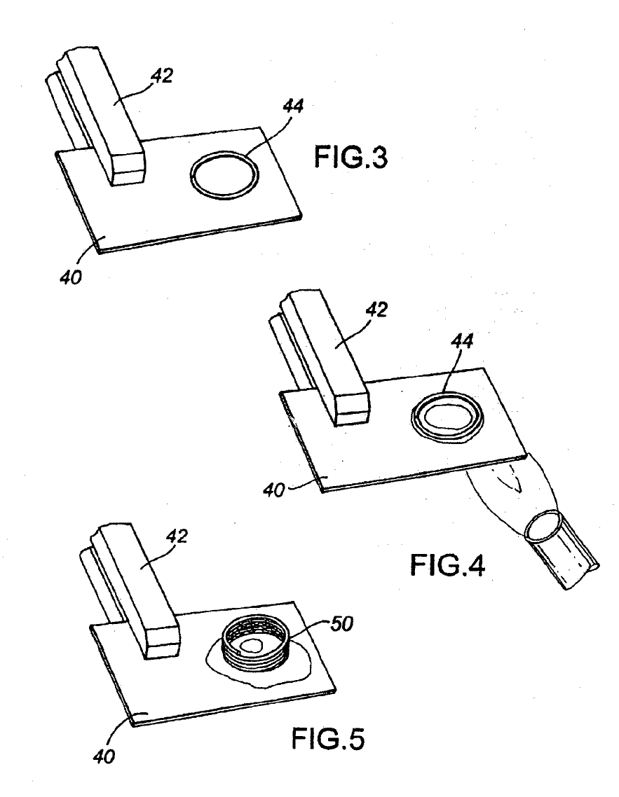

The metal alloy strip 12 may be formed or bowed into a brazing wire having a cross-section of any desired shape and size. For example, the strip 12 may be rolled about its longitudinal axis in a substantially circular manner to form the wire 10 in FIG. 2. Once rolled, a length of the wire may be shaped, twisted, or molded into various shapes, for example, adopting a configuration that is complementary to the various angles and sizes of the surfaces to be brazed. In specific embodiments, as illustrated in FIGS. 3 to 5, the wire can be formed into braze rings or helical loops having a circular cross-section, and further having a wire diameter between about 0.031 and 0.125 inches.

As mentioned, the seamed flux cored brazing wire 10 may be manufactured by other techniques that are known in the art. For example, roll-forming technology, alone and in combination with dies, can be employed to produce a cored wire. The cored wires may also be produced with a gap to allow flux dispersion from the seam.

Cored wire with a butt seam may also be produced and, due to other factors (like an oval, square or other shape of preforms made from the wire) the flux will be allowed to escape from the seam during brazing.

FIGS. 3 to 5 demonstrate flux distribution along the seam of flux-coated wire preforms made according to the invention. A copper coupon 40 is held in place by a clamping device 42 and suspended in the horizontal position. A flux-cored ring (preform 44 made from a length of seamed flux cored wire) is set upon the top surface of the copper coupon 40. Heat (from a propane, butane, or similar torch) is applied to the bottom of the coupon.

When the flux-cored preform 44 reaches a temperature between 500 and 1100° F., flux can be seen dispersing from the wire seam uniformly along the full circumference of the preform 44 as shown in FIG. 4. Note the metal alloy strip is still in solid form, but the flux is being uniformly dispensed from the seam around the entire ring preform.

FIG. 5 shows a multi-turn helical loop preform 50 according to the invention, wherein the coupon 40 and the preform 50 are heated sufficient to cause molten flux material to disperse uniformly from a seam along the inner circumference of the preform, and then evenly over the top surface of the coupon 40.

While there have been described what are at present considered to be the preferred embodiments of this invention, it will be obvious to those skilled in the art that various changes and modifications may be made thin without departing from the true spirit and scope of the invention defined by the following claims.

1. A brazing material used to join two surfaces, comprising:
an alloy having a body that is preformed to complement a shape of at least one of the two surfaces to be joined; and
a flux material retained by the body;
wherein a portion of the flux material is free to flow away from the body along a flow path defined between a first edge portion and a second edge portion of the body, and wherein the flux material melts at a lower temperature than the alloy and flows from the body in a generally uniform manner to treat the two surfaces to be joined.

2. The brazing material of claim 1 wherein the flux material is distributed evenly along a length of the preformed body.

3. The brazing material of claim 1 wherein the flux material is distributed evenly along a circumference of the preformed body.

4. The brazing material of claim 3 wherein the flux material is distributed evenly along an inner circumference of the preformed body.

5. The brazing material of claim 1 wherein the body is made of one of the following alloys: aluminum-silicon; zinc-aluminum; copper-zinc; silver-copper-zinc; silver-copper-zinc-tin; silver-copper-zinc-tin-nickel; silver-copper-zinc-nickel; silver-copper-tin; silver-copper-zinc-manganese-nickel; silver-copper-zinc-cadmium; and silver-copper-zinc-cadmium-nickel.

6. The brazing material of claim 1 wherein the preformed body has a circular shape.

7. The brazing material of claim 1 wherein the first edge portion is an inner edge portion, wherein the second edge portion is an outer edge portion, and wherein the first edge portion and second edge portion overlap one another.

8. The brazing material of claim 1 wherein the first edge portion and the second edge portion collectively define a butt seam through which the flux material is free to flow when appropriately heated.

9. The brazing material of claim 1, wherein the first edge portion and the second edge portion collectively define a gap through which the flux material is free to flow when appropriately heated.

10. The brazing material of claim 1 wherein the flux material disperses from the preformed body at temperatures between about 500° F. and 1100° F.

11. The brazing material of claim 1 wherein the body is formed from one of a rolled sheet or a strip of material pressed through a die to form a channel therein.

12. The brazing material of claim 1 wherein a cross-section of the body is generally uniform along the length of the body, is generally U-shaped, and has a first edge portion and a second edge portion defining a flow path therebetween.

13. The brazing material of claim 1 wherein:
the body is a length of wire, wherein the flow path passes through a longitudinal seam or gap extending over the length of the wire;
the length of wire is preformed into a loop having a certain circumference, the circumference complementing the shape of at least one of the two surfaces to be joined; and
the seam or gap is in communication with a channel such that when the brazing material is heated, the flux material flows from and exits the channel out of the seam or gap.

14. The brazing material of claim 13 wherein the first edge portion and the second edge portion collectively define a gap through which the flux material is free to flow when appropriately heated.

15. A flux cored brazing preform for joining a first surface and a second surface, comprising:
a preform body in the shape of a loop having a plurality of surfaces including a first terminal end, a second terminal end, an outer circumferential surface and an inner circumferential surface, and wherein the plurality of surfaces collectively define a volume;
a flux material contained within the volume; and
wherein the inner circumferential surface is defined by a first edge portion and a second edge portion that extend along the preform body between the first terminal end and the second terminal end, wherein the first edge portion and the second edge portion collectively define a flow path for the flux material to flow out of the volume and away from the inner circumferential surface when suitably heated to a first melting temperature that is lower than a second melting temperature of the preform body.

16. The brazing preform of claim 15 wherein the preform body is made of a zinc-aluminum alloy.

17. The brazing preform of claim 15 wherein the first edge portion and the second edge portion are spaced from one another to form a gap.

18. The brazing material of claim 15 wherein the flux material flows while the preform body is still in solid form and the flux material performs at least one of the following:
removes oxides present on the first and second surfaces, inhibits further oxide formation on the first and second surfaces, and promotes the flow of molten alloy when the preform body is heated to a temperature above the second melting temperature.

19. A preform suitable for use in brazing components to one another, comprising a ring defined by a body that retains a volume of flux material such that when the flux material is heated to its melting temperature, the flux material flows toward a center of the ring before the ring begins to melt.

20. The brazing material of claim 19 wherein the ring comprises:
a first longitudinal edge portion; and
a second longitudinal edge portion;
wherein the first longitudinal and second longitudinal edge portions are spaced from one another to define a flow path therebetween; and
wherein the flux material flows along the flow path when heated to a temperature between 500° F. and 1100° F.

21. The brazing material of claim 19 wherein the ring comprises a silver alloy.
